(19) United States
(12) Patent Application Publication
(10) Pub. No.: US 2015/0011309 A1
(43) Pub. Date: Jan. 8, 2015

(54) QR Code Scoring System

(71) Applicant: Raw Thrills, Inc., Skokie, IL (US)

(72) Inventors: Andrew ELOFF, Skokie, IL (US); Stephen Jacob HACK, Deerfield, IL (US); Eugene Peyton JARVIS, Glenview, IL (US); Anthony B. McCALL, Skokie, IL (US); Torre D'Artagnan WHITMORE, Skokie, IL (US)

(21) Appl. No.: 14/323,616

(22) Filed: Jul. 3, 2014

Related U.S. Application Data
(60) Provisional application No. 61/842,584, filed on Jul. 3, 2013.

(51) Int. Cl. A63F 13/00

(52) U.S. Cl. CPC A63F 13/00; A63F 2300/61
USPC 463/29

(57) ABSTRACT

A videogame, method, or system incorporates the use of a QR Code which is produced by a central processing unit of a game, and is scanned by the player's or user's mobile communication device such as a smartphone. The smartphone's means for network connection to the internet is then used to communicate the game's data to a server associated with the game. In another embodiment, the player's smartphone, using its network connection to a server via a software application or browser, obtains a QR code containing data from a server to display on the phone's screen, for a camera or scanner of the game to scan, thus transferring the data in the QR code to the game's central processing unit, which parses the data and uses it to unlock game benefits for the player to use on the game.

### CROSS-REFERENCE TO RELATED APPLICATIONS

This application claims the benefit of U.S. Provisional Patent Application No. 61/842,584, filed Jul. 3, 2013, and said provisional application and all contents thereof are hereby incorporated by reference herein, in their entirety.

### BACKGROUND OF THE INVENTION

The coin-operated video game industry has changed considerably in the past 40 years. For the first 20 years, games were played in video arcades. Arcades typically had 20 to 40 video games and were frequented by regular patrons, who enjoyed coming back to the same location and perfecting their skills on specific games. These patrons, when sufficiently skilled, would be able to attain a score that would let them claim a spot on the high score table—a listing that was displayed on the game screen between game plays. The high score table conferred some degree of honor and respect upon the patron and created a sense of competition, but also community. Both of these factors led to higher plays and increased revenue in the arcades.

The last 20 years have seen the video games increasingly installed in casual locations, such as amusement parks, theaters, and family entertainment centers. As opposed to video arcades, these locations tend to have a lower concentration of skilled players. As a result, the competitive nexus that exists in the video arcade does not naturally occur in these more casual locations.

However, the rise of the Internet and networked devices has led to the ability to connect remote locations and, by extension, players, to create virtual arcade environments. Over the last 20 years, manufacturers have tried to connect locations in order to create this sense of competition to drive repeat play. However, there have been a number of problems that have limited successful deployment on a mass scale.

First, network installations are expensive and cumbersome and involve setup costs as well as recurring subscription fees. IT personnel will have to install the network hardware and potentially configure the router to accept this special online traffic. In addition, the subscription fees may represent a significant fraction of the total game revenue.

Installing the game on the location's network is a less expensive option. However, it is usually unacceptable, since the location's network typically is trusted and is not amenable to outside and untrusted equipment. Further, the online system would typically require a router configuration change which is a big burden and hassle for the location's IT staff. It also reduces the security of the location's network infrastructure.

Furthermore, the network has to be maintained. Router problems, service outages, cable damage or disconnection all have to be dealt with in order to keep the online system running. At any point in time a significant percentage of these remote games may have some problem that requires a reboot or reconnection.

Finally, the implementation and maintenance of the system is complex and involved. Network traversal, handshaking, protocols, and other algorithms and code need to be developed, maintained, and updated.

As a result of these cumbersome and expensive requirements, a cost-effective online solution that has had broad diffusion in the marketplace has been rare.

### BRIEF SUMMARY OF THE INVENTION

The present invention eliminates the need for cumbersome internet connection requirements and provides a simple and robust solution to providing online connectivity. Basically, the videogame, method, or proposed system produces and displays a “QR Code”—a checkerboard pattern or matrix that is essentially a 2-dimensional barcode—which is scanned by the player's or user's smartphone. QR Codes are well known. See: http://en.wikipedia.org/wiki/QR_code. The player's or user's smartphone's internet connection is then used to communicate the game's data to the server. In other embodiments, the player's smartphone, using its network connection to a server via a software application or browser, obtains a QR code containing data from a server to display on the phone's screen, for a camera or scanner of the game to scan, thus transferring the data in the QR code to the game CPU, which parses the data and uses it to unlock game benefits for the player to use on the game.

### BRIEF DESCRIPTION OF THE SEVERAL VIEWS OF THE DRAWINGS

FIG. 1 is a schematic block diagram of a game.

FIG. 2 is a flowchart showing the order of actions for the process where a QR Code is generated upon completion of a game.

FIG. 3 is a flowchart showing the order of actions for the process where a QR Code is generated outside of gameplay mode by a person (such as a technician or attendant).

FIG. 4 is a flowchart showing the process where a free game or incentive is offered in exchange for scanning a QR code.

FIG. 5 is a flowchart showing the process where a player can upload data to the game using the game's scanning apparatus (such as a camera).

FIG. 6 is a representation of the screen display that results from the process shown in FIG. 1. It shows the QR Code on the screen of the game for the player to scan.

FIG. 7 is a representation of the screen display that is presented as a result of the process of FIG. 4, where a player is offered the chance to scan a code to receive an incentive.

FIG. 8 is a representation of a mobile network-connected device (such as a smartphone) showing the result of scanning the QR Code that is offered as an incentive. The screen shows a code that is entered into the game to claim the incentive.

FIG. 9 is a representation of the game screen display that shows the successful entry of the game code.

FIG. 10 is a representation of the screen display showing the player entry of a name for a high score after completion of a game.

FIG. 11 is a representation of the screen display of a web browser or program that results on the player's mobile network-connected device as a result of scanning the QR code.

FIG. 12 is a representation of the encoding process for the high score sharing QR code, from a text string to the resulting QR code.

FIG. 13 is a representation of the encoding process for the incentive QR code, from a text string to the resulting QR code.

FIG. 14 is a schematic depiction of a player or user using a mobile device to scan a QR code displayed by the game on the game screen.

FIG. 15 is a schematic depiction of a player or user having a QR code that is displayed on a mobile device scanned by the game's camera or scanner.

### DETAILED DESCRIPTION OF THE INVENTION

The QR infrastructure opens up many new options for sharing information and building player loyalty. For example, a feature where the player is given a free game play credit in exchange for uploading game statistics was created. A QR code is also shown on the screen at certain times when the game is not being played. The code is advertised with an enticement to scan for a free game. The code is scanned by the player, which uploads the data about the game (statistics, failures, etc.) to the server. The server then displays a 4 digit code which the player then can enter into the game in order to get a free play.

Additionally, with the addition of a camera added to the game, QR codes can be used to upload data back to the game as well. For example, any scores or cars earned, or other game state (continue point, progress) in a driving game can be stored to the server via QR code. At a later date, they can be downloaded when the game scans a QR code on the player's smartphone. Also, a player can use their smartphone to upload photos to the server.

There are many objectives and benefits. For the player: the player can share their high scores or good times with their friends, by social media or other formats. The player can enter tournaments where a high score or number of games played is required. Also, a player can be notified when her high score is beaten by registering an email address.

For everyone else, there are more benefits that accrue. First, the operator/owner of the game doesn't have to provide internet service for the game, but it can provide internet-style connectivity through the transmission of the QR code data. The developer and manufacturer of the game benefits in that it can find out a wide variety of useful data about the game, such as where the game is located, status information about the game, software information such as version in use, the serial number of the game, and all of the game adjustments in force (such as price per play, difficulty settings, etc.). Also, the developers can find out diagnostic information, such as crashes or other problems. This diagnostic information will allow for better quality games. In fact, a great deal of valuable information can be transferred both to and from a game using the inventive method and system.

In one embodiment, the player starts and plays a game. When the game is complete, the game CPU decides based on predetermined criteria if the player should enter a name. The CPU then takes some combination of information such as the player's name, game-related information (such as track played, vehicle used, etc.), various scores and metrics (such as high scores, fast times, and other metrics), additional information about the game (such as game adjustments, game audits and statistics, and software or hardware failure reports), and generates a text string from this data.

The data is then encoded by an encoding method (many encoding methods are known in the field) into a string that is able to be converted into a QR code. The encoding is used to obscure or discourage reverse engineering the text data being sent. If the text data is reverse-engineered or modified, the player could possibly modify values (such as the high score entry or serial number), to unjustly claim a higher score, or fool the server into thinking that the score is better than it actually is.

The data is then appended to a Uniform Resource Locator (URL) that contains information required to access a server. The appended text conforms to the URL standard, and thus forms part of a longer URL.

The inventors have developed the following specific embodiments of the invention.

### Method 1

First, the player can play a game. She can get some high scores or records of some kind. At the end of the game, she uses a scanning application on her mobile device having a cellular telephone or other means of connection to the internet (such as a smartphone) to scan a QR code that displayed on the screen of the game. That QR code, when scanned, launches a web browser in her smartphone, leading to the display of a website on the smartphone screen, pointing to a high score table website. The scores are automatically inserted into the website.

The website displayed on the phone screen prompts the player to share her location information. If she agrees, the phone's geolocation application is activated, and the geolocation data is associated with the QR code scan. The location information can be accumulated among many players of the game in servers, so as to offer the game owner, developer, and manufacturer means for collecting, interpreting, and using geolocation information concerning the games and players. This provides, for example, a global map of all games and a way to find out where each game is placed, serial numbers of the games played, their software versions, etc.

The website also prompts the player to enter an email address on the phone. If the player provides the address, then the server can maintain this information and be configured to send email messages to the player, such as a message informing the player when her high score has been beaten, or messages providing advertisements or incentives related to the game or to other games. The email address gets tied to data including the high score and information about the particular game machine the user played, such as location.

Finally, the player is given the option to share her score on social media sites (such as Facebook or Twitter). This enables the player to share their experience but also gives the game owner, developer, and/or manufacturer access to demographic and other information about the player.

The process or system of Method 1 can be summarized as follows:

1. Player finishes game, attains scores.
2. Player enters high score name (optional)
3. Game takes score information and high score name and creates a text string.
4. Text string is encoded and appended to a URL
5. URL is converted into a QR Code
6. QR Code is displayed on the game's display screen for 6 minutes following a game
7. Player downloads a QR Code scanning app (if player doesn't already have)
8. Player scans QR Code
9. Scanner converts QR code to URL, jumps to page
10. Server requests player location information (optional)
11. Server tests text string—if string is tampered with, server rejects string
12. Server decodes text string
13. Server adds scores to high score table
14. Server presents a web page asking if player wants to share page on a social media site such as Facebook or Twitter. It will also ask if the player wants to enter email address to be notified when player's high score is beaten.
15. If player enters email address, it is tied to all high score entries at that time.

### Method 2

A user (typically a technician, operator, attendant, or sales person who works on maintaining operation of the game) approaches the game machine while it is not being played. She initiates a process in the game's central processing unit (“CPU”), typically by button press or some other type of input device or system built in to the game. The initiation of the process results in the CPU generating a QR code, and the code being displayed on the display screen of the game.

The QR code contains encoded data, including information about the game such as software version and serial number; audits on play data and statistics, such as number of games played and average time per play; game adjustments such as price per play and difficulty levels and settings; and diagnostics such as history of software failures and hardware failures. The user scans the QR code, using a scanning device such as a scanner or a smartphone with scanning capabilities. The scanned QR code launches a web browser using the phone's network connection to connect to a server. The server receives the data encoded in the QR code, decodes the QR Code data, parses the data, and saves the data for future use. Optionally, the phone screen then can display to the user selected data that was contained in the QR code. The user can then review the displayed data, and use the data as appropriate to plan for or make adjustments or repairs to the machine.

### Method 3

A potential player is incentivized to scan a QR code before playing a game. The incentive may be a discounted or free game, or in-game upgrade (better vehicle/weapon/sports team). In order for this system to be used one time only, a special type of code system needs to be implemented.

First, both the game and server need to have the same list of a fairly large number of matched pairs of codewords, with each pair having a “challenge” and a “response”. The game then selects one of the pairs of codewords and uses the “challenge” part as part of the text string used to generate the QR code. Then, it waits for the user to type in the correct response. The CPU can safely assume that the only way the correct response can be input is because the player received the response from the server. Once the response is received correctly, it no longer allows that response to be used again, unless at some future point the same challenge is presented.

The QR code contains information about the game (as in the first two methods) but also contains this challenge codeword. When the QR code is scanned, the data is uploaded as in the previous two methods. In addition, the challenge codeword is looked up by the server and the corresponding response codeword is shown in the browser. The player can then enter this response into the game using buttons or other input devices connected to the CPU.

### Method 4

In Method 4, the player starts a game, and also the player starts execution of a program on the player's mobile network-connected device, such as a smartphone. The program can be a browser, software application (app), or other feature on the phone that connects the phone to a website and associated server for the game. The server generates a QR code containing a data payload very similar to that used in the Methods 1 through 3, which the mobile device obtains via its network connection with the server. The phone then displays the QR code on its display screen, and the player holds the mobile device's display near the game's camera or scanner. In this way, the game camera or scanner can read the QR code displayed on the mobile device. Then the game's CPU decodes the data contained within the QR code, and uses the data to unlock features or offer premium features, or a free game to the player. This method also offers a way to convey game data from the server to the game that is data unrelated to the premium features offered to the player, such as data useful for updating, repairing, or maintaining the game.

### DISCUSSION IN REFERENCE TO DRAWING FIGURES

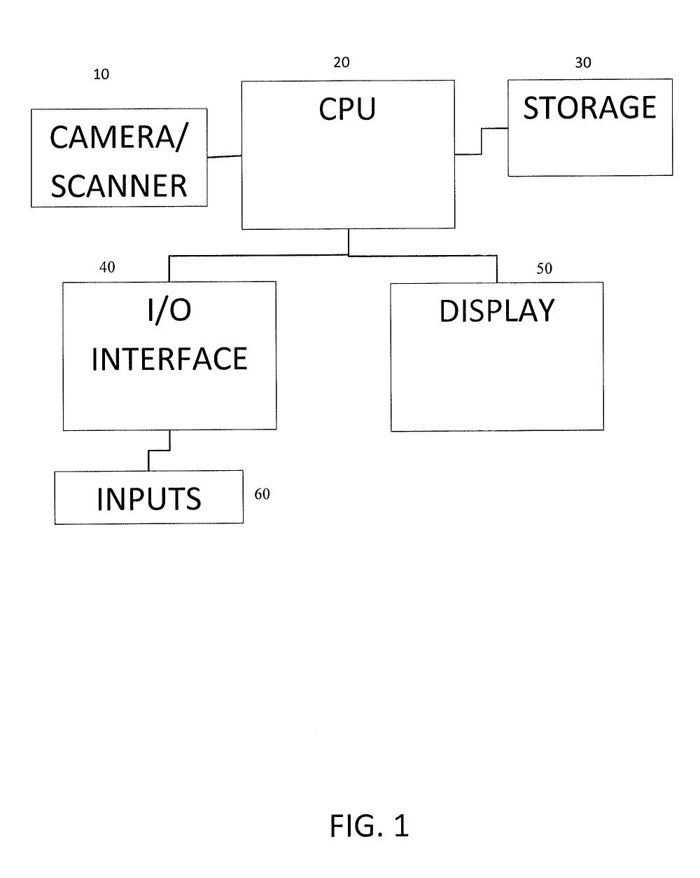

FIG. 1 is a schematic block diagram of a game. The game is comprised of the CPU indicated in block 20, with a memory storage unit shown in block 30 and a display or displays in block 50. The I/O interface or interfaces shown in block 40 allows the CPU to accept and process switch and analog inputs represented in block 60, such as buttons and potentiometers, and also coin switches or other methods to accept credit for play. In addition, the I/O interface or interfaces can process outputs, such as light emitting diodes (LED's) or motors. Optionally, a camera or scanner may be used in the game, as shown in block 10.

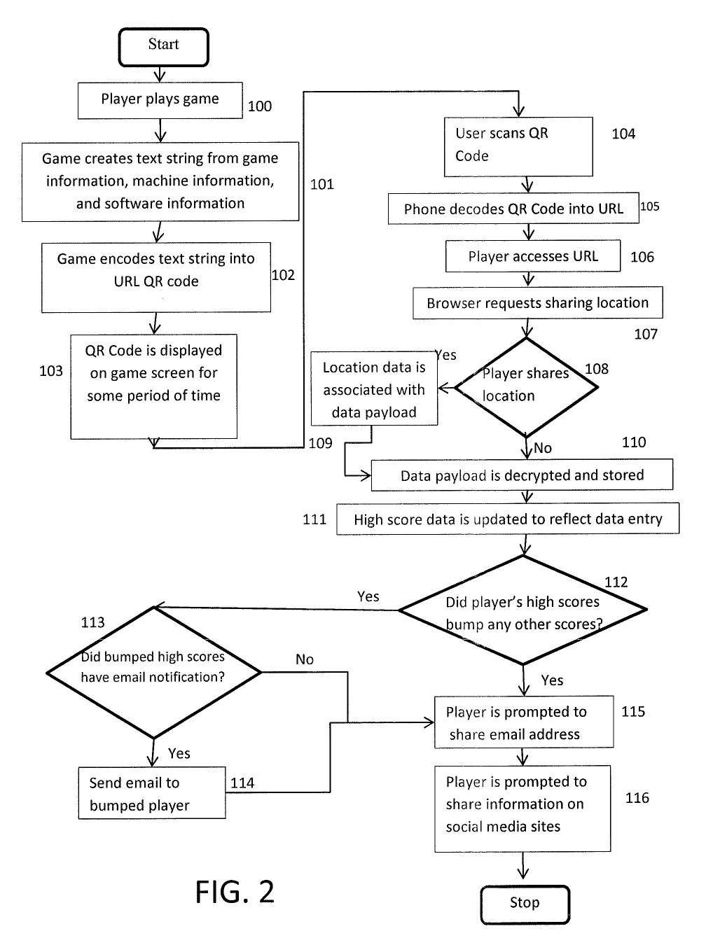

FIG. 2 is a flow diagram describing the process described above as Method 1. In block 100, the player starts and completes play on a game machine. In block 101, the CPU collects information about some combination of gameplay, machine information, software states, hardware states, and storage media data, and assembles a text string, which is generally referred to herein as the “data payload”. Optionally, the data is encrypted so to prevent analysis or reverse engineering. In block 102, the CPU encodes this text string into a Universal Resource Locator (URL) string that points to a server on a network. Then, a QR Code is generated from that URL. In block 103, the QR code is displayed on screen for scanning by a network-connected scanning device (such as a cellular phone). This code is displayed for some period of time to ensure that the player is sufficiently able to scan the code, as indicated in block 104.

In block 105, the phone decodes the QR Code back into a URL. Then, a browser or other URL processing application in the phone reaches the network with the URL, depicted in block 106. The browser or URL processing application sends the data contained within the URL to a server. Optionally, in blocks 107 to 109, the server sends back via the network connection to the player's mobile device a request for the player to share the device's location with the server. If the player consents, the geolocation services of the device send location information to the server via the mobile device's network connection with the server.

Following that, in block 110, the data payload text string is decrypted, if it was encrypted first, and is saved in the game's storage media. In block 111, the data entries are entered into the high score database (typically called a high score table) and the new data is displayed for the player. Optionally, in block 112, the CPU checks to see if any other high score entries made by other players were displaced as a result of the new entries. If so, the CPU sends an email to the players whose scores have been demoted (blocks 113 and 114).

The player is then optionally requested to enter an email address for subsequent notifications in block 115. Finally, the player optionally may share the score information and game experience via social media services in block 116.

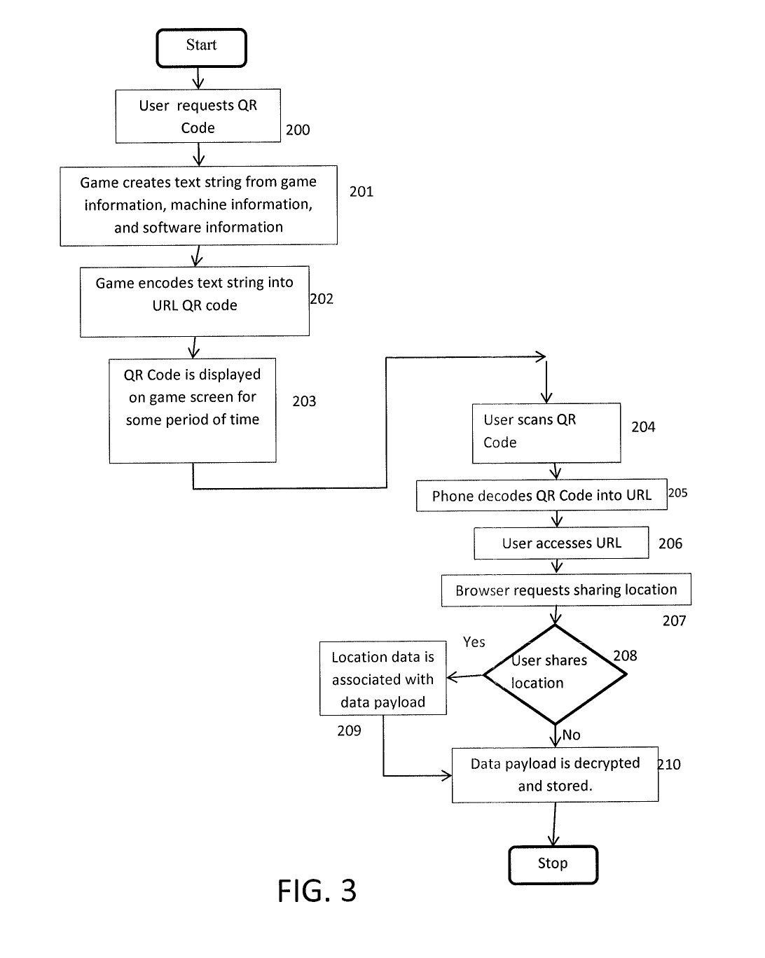

FIG. 3 is a flow diagram describing the process described above as Method 2. In block 200, the user requests a QR code from the game. Typically, this request is made by typical input means such as a sequence of button presses or other manipulation of input devices or systems on the game. The request signals the game's CPU, in block 201, to generate a text string data payload containing information about the game, such as data about gameplay, machine information, software states, hardware states, and storage media data. In block 202, the game CPU encodes this text string into a Universal Resource Locator (URL) string that points to a server on a network. Then, the CPU generates a QR Code from that URL. In block 203, the QR code is displayed on game screen for scanning by the user's network-connected scanning device (such as a handheld scanner or a cellular phone). This code is displayed for some period of time to ensure that the user is sufficiently able to scan the code, as indicated in block 204.

In block 205, the phone decodes the QR Code back into a URL. Then, a browser or other URL processing application of the phone reaches the network with the URL. The browser or URL processing application sends the data contained within the URL to a server, connecting the user with the URL as depicted in block 206. Optionally, in blocks 207 to 209, the server sends back, via the network connection between the server and the phone, a request for the user to share the device's location with the server. If the user consents, the geolocation services of the device send location information to the server.

Following that, in block 210, the server decrypts the data payload text string, if it was encrypted first, and then the server parses, stores, and saves the data in the server's storage media. The server and its storage media thus can remotely obtain, interpret, and store updated data about this particular game that was contained in the data payload text string. This sort of data about the game can include useful information such as information about gameplay, machine information, software states, hardware states, and storage media data. This data can then be used by the game owner, developer or manufacturer to help plan or conduct repairs, maintenance, upgrades, adjustments, or updates to the particular game in question, or to game hardware, processes, or software system-wide.

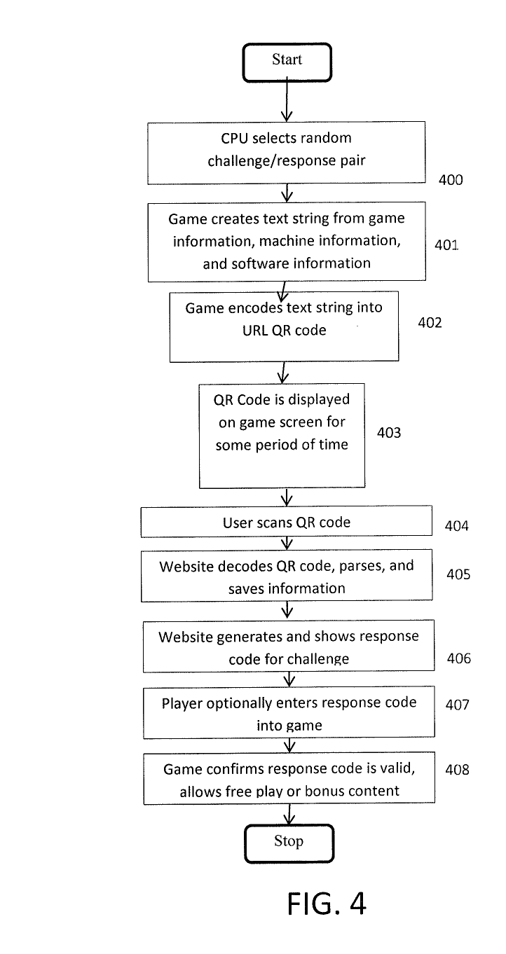

FIG. 4 is a flow diagram describing Method 3. The game, based on predetermined criteria, initiates the process of assembling data for transmission via QR code. In block 400, the game CPU randomly selects a challenge/response pair of codewords from a predetermined set of pairs that both the machine and the server share. Then, in block 401, the CPU generates a text string data payload containing information about the game including the challenge codeword, gameplay, machine information, software states, hardware states, and storage media data. In block 402, the game CPU encodes this text string into a Universal Resource Locator (URL) string that points to a server on a network. Then, a QR Code is generated from that URL.

In block 403, the QR code is displayed on the screen of the game for scanning by a network-connected scanning device (such as a cellular phone). This code is displayed for some period of time to ensure that the player is sufficiently able to scan the code, as indicated in block 404.

At this point the player scans the QR code displayed on the game screen using her phone, and the phone decodes the QR Code back into a URL. Then, a browser or some URL processing application in the phone reaches the network with the URL using the phone's network connection capabilities. This sends the data contained within the URL to a server. In block 405, the server, upon receiving the URL, decodes the encrypted data payload, parses it, and stores the data. In block 406, the server determines the appropriate response for the received challenge codeword contained within the data payload. The server then provides the response code along with some other information to the player by conveying the code through the network connection with the player's phone, displaying the code via the website displayed on screen of the player's device.

Using some form of available input means or system in the game (such as switches, analog inputs, camera or scanner), the player then enters the response code into the game, indicated in block 407. The game CPU then verifies that the response code is valid and allows some premium to the player, as shown in block 408, such as free gameplay or bonus content, such as a car upgrade or more powerful weapon.

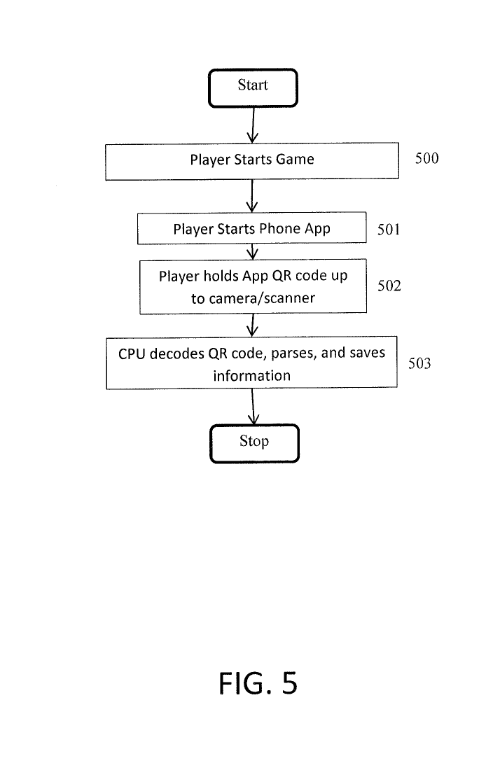

FIG. 5 is a flow diagram describing Method 4. In this process the player starts a game, shown in block 500. Also, the player starts execution of a program on the player's mobile network-connected device (such as a smartphone), as shown in block 501. The execution of the program on the phone activates a network connection to the server associated with the game. The server provides a data payload text string that is converted by the server into a QR code. The server conveys the QR code to the phone via the network connection, and then the mobile device displays the QR code containing the data payload on the phone screen by displaying the associated web page.

In block 502, the player holds the mobile device's display to a game's camera or scanner. In this way, the game can read the QR code displayed on the mobile device's screen. In block 503, the game CPU decodes, and can parse and save, the data contained within the scanned QR code and uses the data to unlock features or offer premium features or a free game to the players. This method also offers a way to convey game data from the server to the game that is data unrelated to the premium features offered to the player, such as data useful for updating, adjusting, repairing, or maintaining the game.

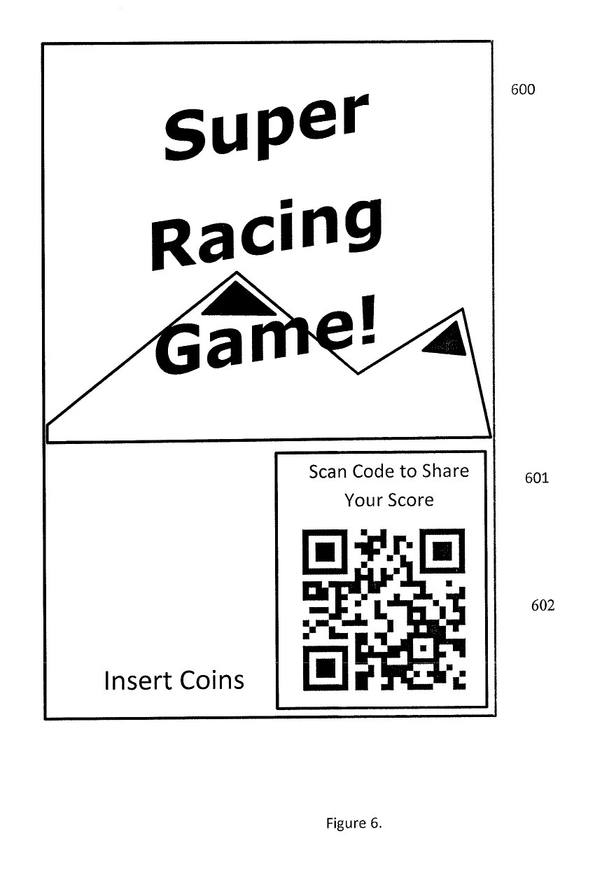

FIG. 6 shows a simulation of the game's display in the mode where a player just completed a game and the Method 1 implementation of the QR process is being used. Box 601 is displayed over the ordinary screen information 600, with encouragement to scan the QR code shown as 602.

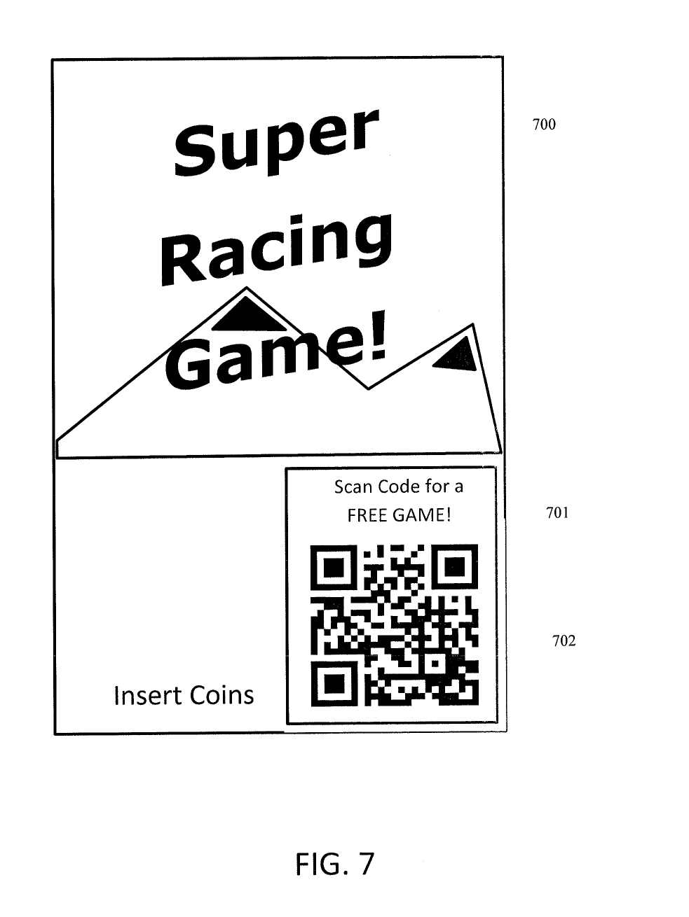

FIG. 7 shows a simulation of the game's display in the mode where the game is waiting to be played and a QR code from the process of Method 3 is used. Box 701 is displayed over the ordinary screen information 700, with encouragement to scan the QR code shown as 702.

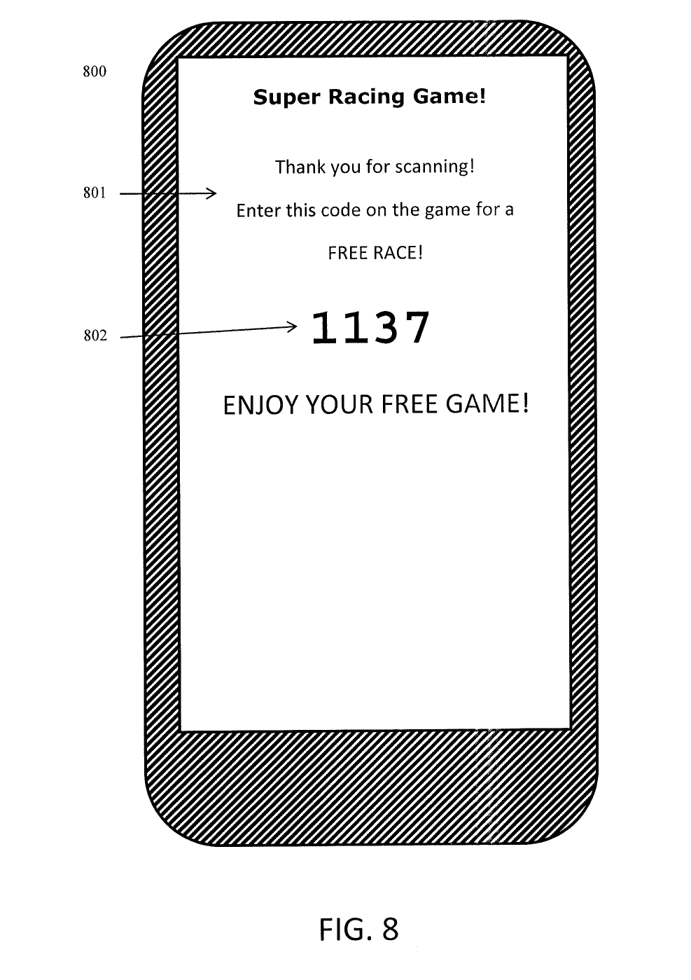

FIG. 8 shows a network-connected mobile device, such as a smartphone as 800, in the process of Method 3. Amongst the display information provided by the device application is a response code 802. This code, when entered into the game, will provide some sort of free benefit to the player.

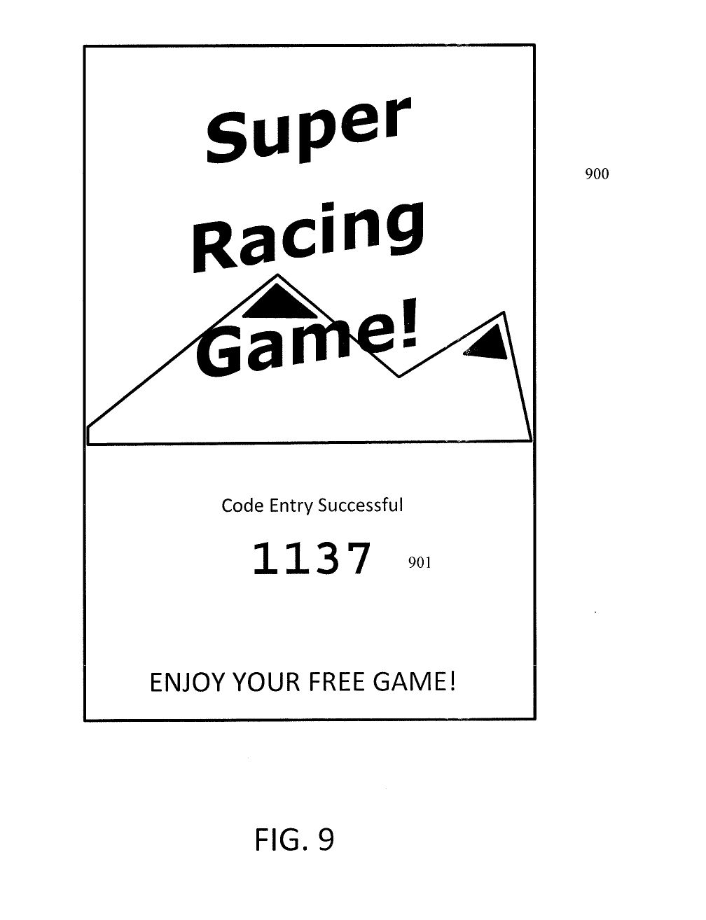

FIG. 9 shows a simulation of the game's display in the mode in Method 3 where a free game is given in exchange for the QR code scan. The screen display 900 allows visual feedback of the entered code 901.

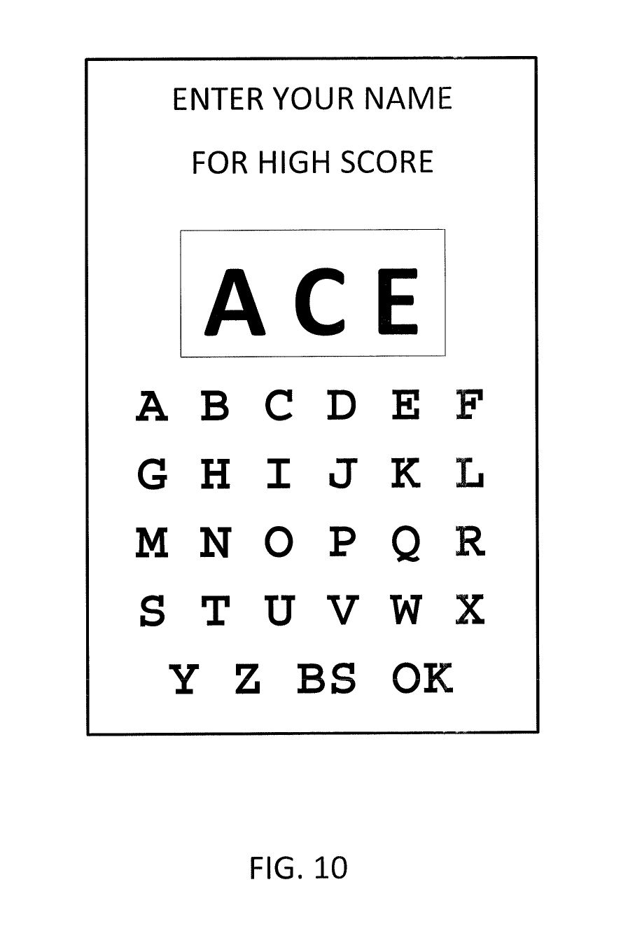

FIG. 10 shows an implementation of a high score table entry.

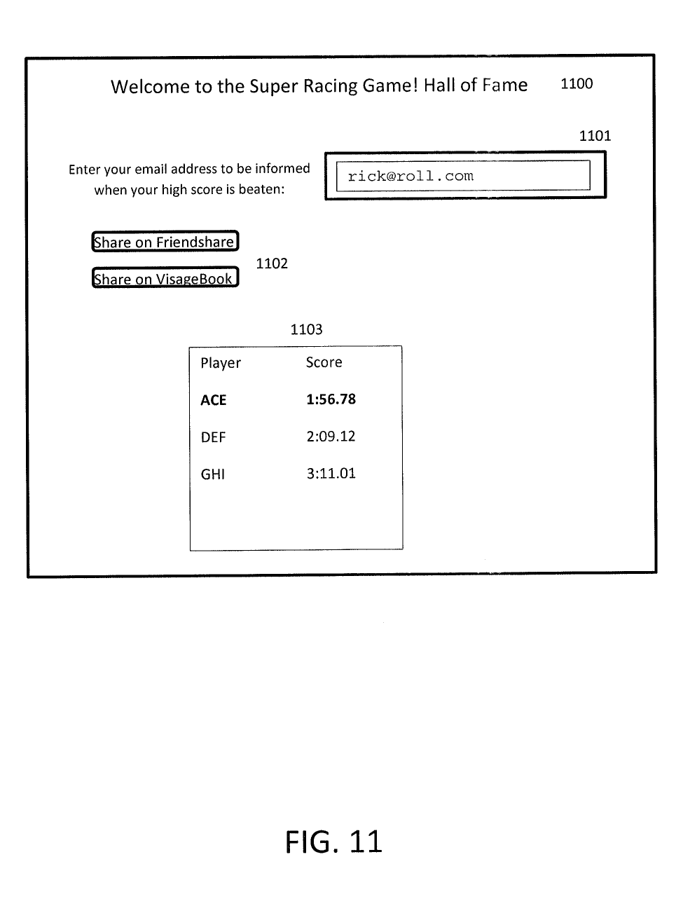

FIG. 11 shows a simulation of a network-connected device after scanning the QR code in Method 1. Underneath the title 1100, an area for the player to enter an email address for notification is shown as 1101. Social media sharing buttons are shown in 1102. 1103 shows a display of aggregated high scores, with the current play highlighted and added according to rank.

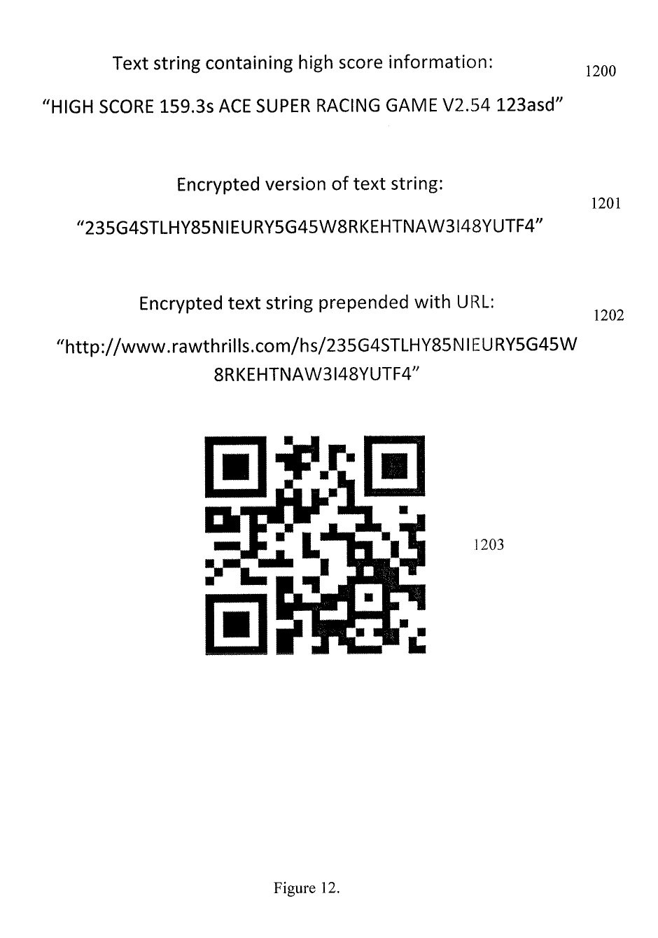

FIG. 12 shows an example set of data for Method 1. 1200 is the string generated by the game CPU including high score information and other information collected from the game state, hardware and software information, and storage media. 1201 shows how the string in 1200 might look after being encrypted. The string 1202 is a Uniform Resource Locator (URL) that contains information about the server and the encrypted string to be sent to the server. The QR code in 1203 represents an encoded version of the URL.

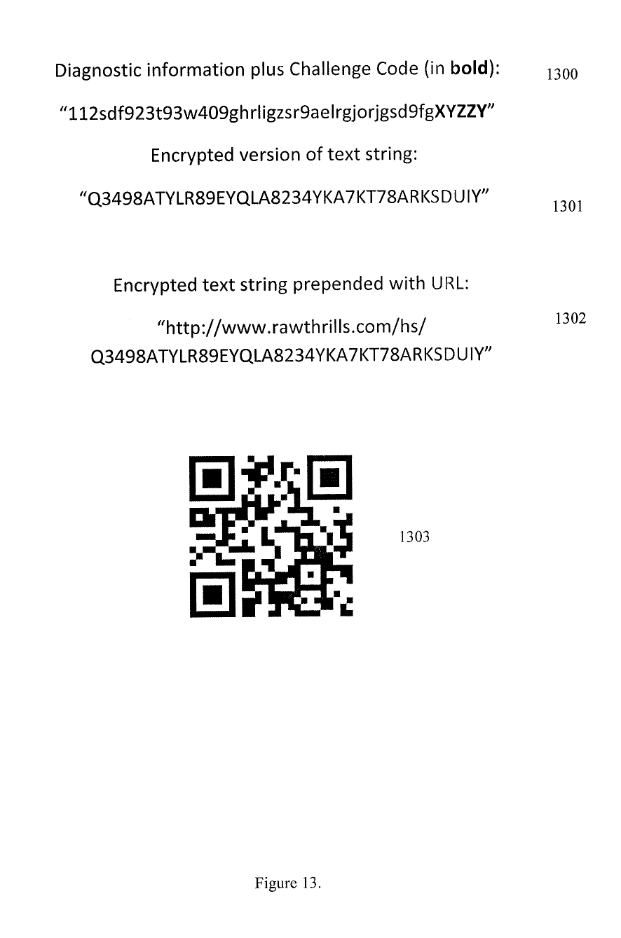

FIG. 13 shows an example set of data for Method 3. 1300 is the string generated by the game CPU including high score information and other information collected from the game state, hardware and software information, and storage media. Note that it is followed by a challenge code, represented here by the bold print “XYZZY”. 1301 shows how the string in 1300 might look after being encrypted. The string 1302 is a Uniform Resource Locator (URL) that contains information about the server and the encrypted string to be sent to the server. The QR code in 1303 represents an encoded version of the URL.

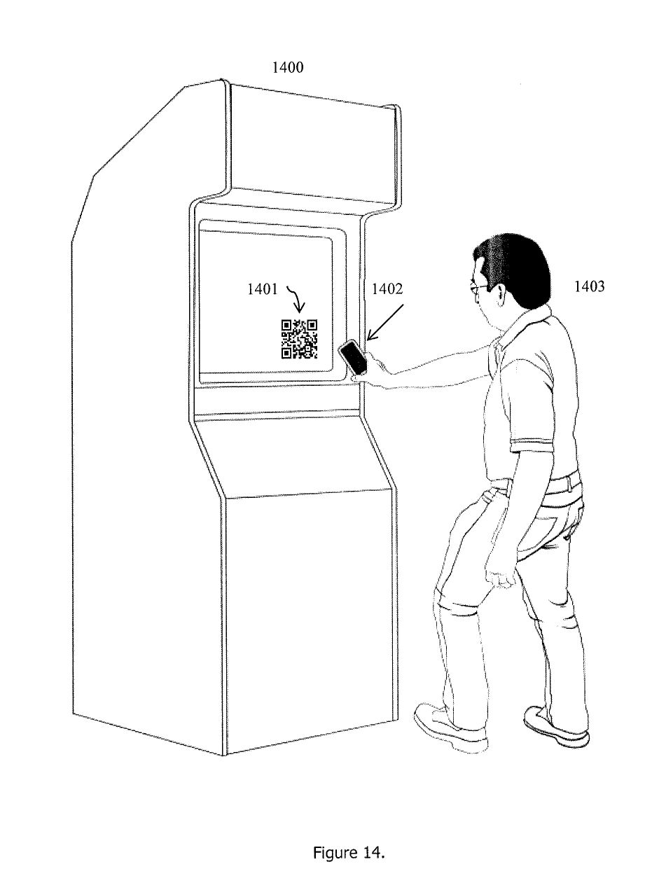

FIG. 14 shows an example of a player 1403 scanning a QR code 1401 under Method 1, Method 2, or Method 3 from a game machine 1400. The user or player 1403 is shown using a network-connected mobile device 1402 such as a smartphone.

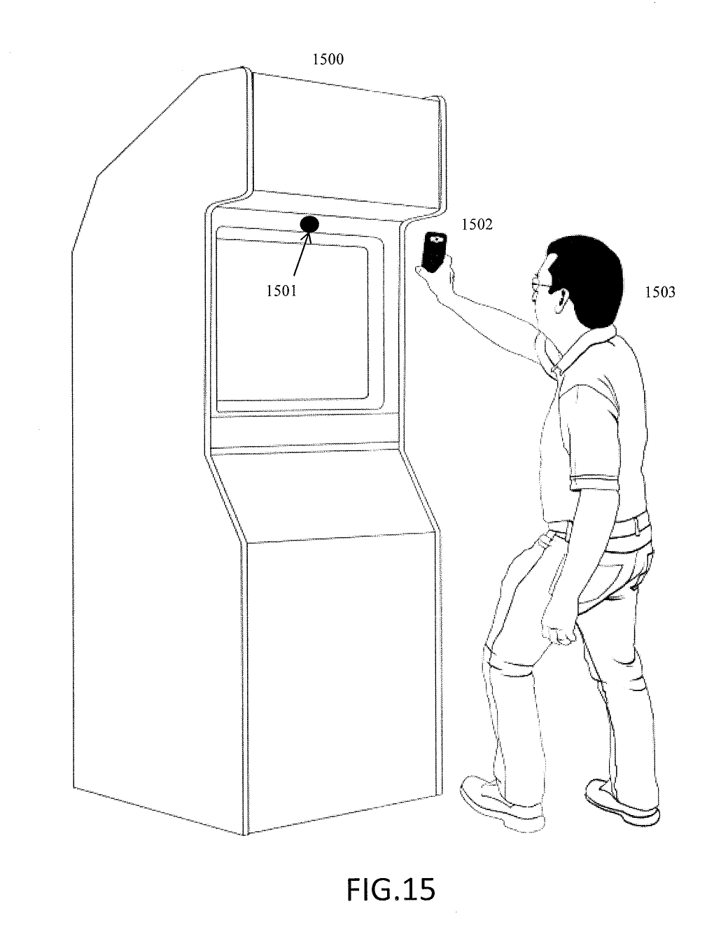

FIG. 15 shows a player 1503 allowing a game machine 1500 to scan the player's network-connected mobile device display 1502 using a camera or scanner 1501 of the game machine 1500. The mobile device display 1502 is displaying a QR code in accord with the method and system of Method 4.

1. A scoring system for a game, comprising:
a game controlling computer means;
player controllable input means for operating the game;
display means providing a visual output of the game action; and
a scoring means for creating and displaying a code on the display means representing the player's score for a particular game played.

2. The scoring system of claim 1 wherein the code is a QR code.

3. The scoring system of claim 1 in which the code includes machine identification information for the game.

4. The scoring system of claim 1 wherein the code includes geolocation information for the game machine.

5. The scoring system of claim 1 further including a mobile device connected to the Internet for scanning the code and transmitting the score to a scorekeeping website server.

6. The game of claim 5 including means for sharing the score on a social media website.

7. A scoring system for a video game comprising:
a video game controlling CPU;
player controllable input means for playing the video game;
a video display; and
a scoring means for displaying a QR code on the display representing the player's score for a particular game.

8. The video game of claim 7 including an instruction set for the CPU for deciding based on predetermined criteria that the player if the player should be identified.

9. The scoring system of claim 7 wherein the code includes geolocation information for the game machine.

10. The scoring system of claim 9 further including a mobile device connected to the Internet for scanning the code and transmitting the score to a scorekeeping website server.

11. The game of claim 10 including means for sharing the score on a social media website.

12. A scoring system for a standalone, coin operated video game, comprising:
a game controlling computer means;
player controllable input means for operating the game;
display means providing a visually perceptible image of the video game action;
a scoring means for creating and displaying a code on the display means representing the player's score for a particular game played; and
a mobile device for scanning the code and transmitting the score to a remove server.

13. The scoring system of claim 12 wherein the code is a QR code.

14. The scoring system of claim 13 in which the code includes video game machine identification information.

15. The scoring system of claim 14 wherein the code includes geolocation information for the video game machine.

16. The scoring system of claim 15 further including a mobile device connected to the Internet for scanning the code and transmitting the score to a scorekeeping website server.

17. The video game of claim 16 including means for sharing the score on a social media website.

18. A scoring system for a video game comprising:
a video game controlling CPU;
player controllable input means for playing the video game;
a video display; and
a scoring means for displaying a QR code on the display representing the player's score for a particular game.

19. The video game of claim 18 including an instruction set for the CPU for deciding based on predetermined criteria that the player if the player should be identified.

20. The scoring system of claim 19 wherein the code includes geolocation information for the video game machine.

21. The scoring system of claim 20 further including a mobile device connected to the Internet for scanning the code and transmitting the score to a scorekeeping website server.

22. The video game of claim 21 including means for sharing the score on a social media website.
